(19) United States
(12) Patent Application Publication
(10) Pub. No.: US 2012/0243861 A1
(43) Pub. Date: Sep. 27, 2012

(54) DOME WINDOW AND SURVEILLANCE CAMERA DEVICE COMPRISING SUCH A DOME WINDOW

(75) Inventors: Sven Svensson, Furulund (SE); Stefan Lundberg, Lund (SE)

(73) Assignee: AXIS AB, Lund (SE)

(21) Appl. No.: 13/428,627

(22) Filed: Mar. 23, 2012

Related U.S. Application Data
(60) Provisional application No. 61/468,789, filed on Mar. 29, 2011.

(30) Foreign Application Priority Data
Mar. 23, 2011 (EP) 11159428.9

(51) Int. Cl. G03B 17/56; G02B 27/00

(52) U.S. Cl. 396/427; 359/894

(57) ABSTRACT

A dome window for a surveillance camera device includes a first section and a second section. The first section is joined to the second section along a joint in which a joint end of the first section is attached to a joint end of the second section. A light absorber is arranged in or on the joint.

### CROSS REFERENCE TO RELATED APPLICATIONS

This application claims the benefit of U.S. Provisional Application No. 61/468,789 filed Mar. 29, 2011 and European Application No. 11159428.9 filed Mar. 23, 2011, which are incorporated by reference as if fully set forth.

### FIELD OF INVENTION

The present invention relates to a dome window and more particular to a dome window for a camera surveillance device. The invention also relates to a surveillance camera device comprising such a dome window.

### BACKGROUND

Surveillance camera devices are generally used to monitor specific areas, such as banks, stores or public places. The camera device is often arranged for rotation and/or tilting in order to enable image acquisition from different positions in the specific area. The surveillance camera device may comprise a hemispherical dome window. The dome window is normally manufactured by an injection moulding process in order to ensure uniform wall thickness.

For some applications, such as outdoor applications, it might be desirable to acquire an image from a position parallel with or above the horizon of the dome window. Since the lens arrangement of the surveillance camera device normally is arranged for tilting and rotation around pivot axes extending through or in the proximity of the centre point of the hemispherical part of the dome window, the dome window may therefore be provided with an additional transparent part adjoining the hemispherical part of the dome window in order to enable viewing in directions parallel with or above the horizon of the dome window.

The additional part may be cylindrical with requisite draft angles and the dome window may in this case be manufactured in one piece by injection moulding. However, the cylindrical part of the dome window affects the quality of the images acquired by the lens arrangement due to aberrations introduced by the dome window being partly non-spherically shaped.

Consequently, the additional part may be given the shape of a spherical segment in order to provide a dome window with a general spherical shape which does not affect the image quality due to aberrations introduced by the dome window being partly non-spherically shaped.

Manufacturing of such a spherical dome window in one piece requires destroying of the mould subsequent to the moulding process which for obvious reasons is a costly way of production. Alternatively, a spherical dome window may be manufactured in two separate parts, for instance the hemispherical part as one section and the part with the shape of a spherical segment as one section. However such a two part dome window results in a joint along which the two sections of the dome window are joined. The joint will affect the quality of the acquired images.

It is thus evident that there is a need for an improved dome window for surveillance camera devices.

### SUMMARY

In view of that stated above, the object of the present invention is to provide an improved dome window for a surveillance camera device.

A further object is to provide such an improved dome window in which the negative effect on image quality of a joint joining two sections of the dome window is eliminated or at least reduced.

It also an object to provide a surveillance camera device comprising such a improved dome window.

To achieve at least one of the above objects and also other objects that will be evident from the following description, a dome window for a surveillance camera device is described herein.

More specifically, there is provided according to the present invention a dome window for a surveillance camera device, comprising a first section and a second section, wherein the first section is joined to the second section along a joint in which a joint end of the first section is attached to a joint end of the second section. The dome window includes a light absorber is arranged in or on the joint.

Since the dome window comprises two sections, the dome window may be manufactured by injection moulding and still be given a general spherical shape. Due to the fact that a light absorber is arranged in or on the joint joining the first and second sections, negative effects on image quality due to light reflections in the joint is eliminated or at least significantly reduced. The joint will only appear as a thin dark line in the line of sight of the lens arrangement when viewing through corresponding parts of the dome window. For most zoom settings, such as zoomed-in situations, the joint in the form of a dark thin line may not be visible at all in the image, the joint only acting as a diaphragm slightly but negligible reducing the amount of incoming light.

The light absorber may according to one embodiment of the present invention comprise a covering with light absorbing properties applied on at least one of the joint ends of the first and second sections. By applying the light absorber in the form of a covering on at least one of the joint ends, it is possible to minimize the width of the joint as perceived by the lens arrangement when viewing through a part of dome window comprising the joint. Alternatively or additionally, the covering may be applied on the inside or the outside of the dome window with an extension over the joint.

The covering with light absorbing properties may be selected from the group consisting of a tape, a double sided tape, a pigmented adhesive and a pigmented coating, ink or paint.

According to another embodiment, the joint ends may have corresponding cross section profiles. Hereby, it will be possible to minimize the joint size and also to provide a guide mutually aligning the first and second sections during the joining of the same.

The first section may have a hemispheric shape and the second section may have a shape of a spherical segment. Specifically, the first and second sections may form parts of a common sphere shape.

According to a further embodiment, the joint may be annular.

According to yet another embodiment, the first section may be a mirror image of the second section.

The wall thickness of the first and second sections may be in the range of 1 to 2 mm. By using a thin wall thickness, the joint width perceived by the lens arrangement may be minimized.

The first and second sections may be made of a plastic material such as PMMA or PC.

Furthermore, according to the present invention, a surveillance camera device is provided comprising a dome window as previously described. The benefits and effects of the inventive dome window stated above are in relevant parts also applicable to the inventive surveillance camera device.

According to one embodiment, the surveillance camera device may comprise a tilt-able or rotatable lens arrangement with a front lens surface arranged at a constant distance D to a hemispherical part of the dome window. The distance D may be in the range of 1-20 mm and more preferably 4-10 mm. The effects by the joint on image quality may be minimized if the distance D is kept as small as possible.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a perspective view of a surveillance camera device according to the present invention.

FIG. 2 is a perspective view of an inventive dome window for the surveillance camera device shown in FIG. 1.

FIG. 3 is a perspective view of a second embodiment of an inventive dome window for a surveillance camera device.

FIG. 4 is an exploded perspective view of the dome window shown in FIG. 2.

FIG. 5 is a partially sectioned side view of third embodiment of an inventive dome window for a surveillance camera device.

FIGS. 6A-C are part sectional views of an inventive dome window showing alternative embodiments of joint ends.

FIG. 7 is a perspective view of a fourth embodiment of an inventive dome window for a surveillance camera device.

### DETAILED DESCRIPTION OF THE PREFERRED EMBODIMENTS

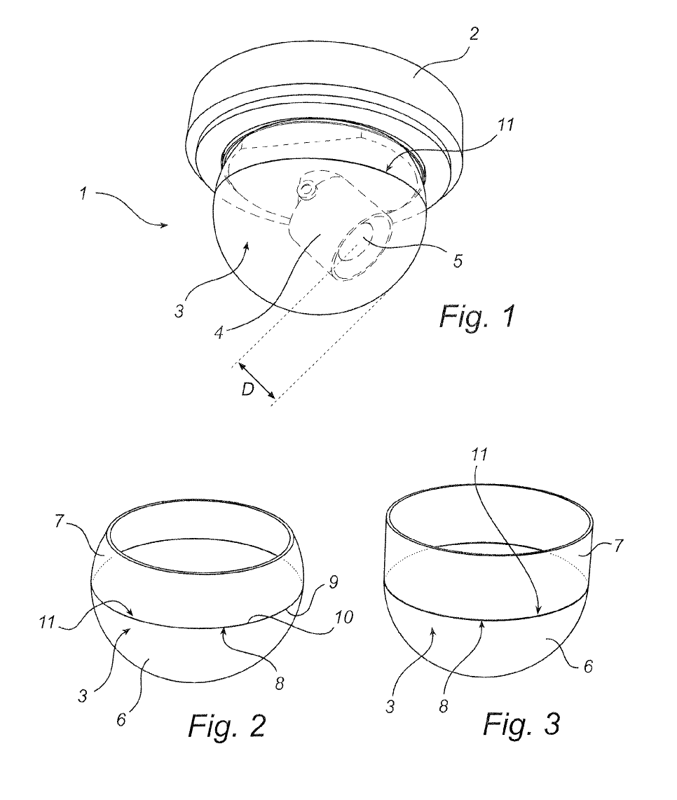

A surveillance camera device 1 in accordance with the present invention is disclosed in FIG. 1.

The surveillance camera device 1 comprises a base 2 supporting a dome window 3 and a lens arrangement 4 (indicated with dashed lines) which is movable by tilting and/or rotation inside the dome window 3. Additional parts or components of the surveillance camera device 1 are not described as they are not needed in order to describe the invention.

A front lens surface 5 of the lens arrangement 4 is arranged at distance D from an inside surface of a hemispherical part of the dome window 3, which distance D is constant during tilting or rotation of the lens arrangement 4. The distance D may be in the range of 1-20 mm and more preferably 4-10 mm.

By the term “dome window” is meant a enclosure or cover arranged to partly enclose the lens arrangement of the surveillance camera device.

The dome window 3 is transparent at least when viewing in outward direction.

As a non limiting example, the dome window 3 may be made of a plastic material such as polymethylmethacrylate (PMMA) or polycarbonate (PC) and have a uniform wall thickness in the range of 1-2 mm.

The dome window 3 may be manufactured by injection moulding in order to ensure such uniform wall thickness.

The dome window 3 of the surveillance camera device 1 is shown in isolation in FIG. 2, to which reference now also is made.

The dome window 3 comprises a first section 6 and a second section 7. In the shown embodiment, the first section 6 is hemispherical and the second section 7 has the shape of a spherical segment. The first and second sections 6, 7 thus form parts of a common sphere shape.

The first section 6 is joined to the second section 7 along a joint 8 in which a joint end 10 of the first section 6 is attached to a joint end 9 of the second section 7. The joint 8 has a horizontal or latitudinal orientation, and as the first section 6 is hemispherical and the second section 7 has the shape of a spherical segment, the joint ends 9, 10, and thus also the joint 8, are annular.

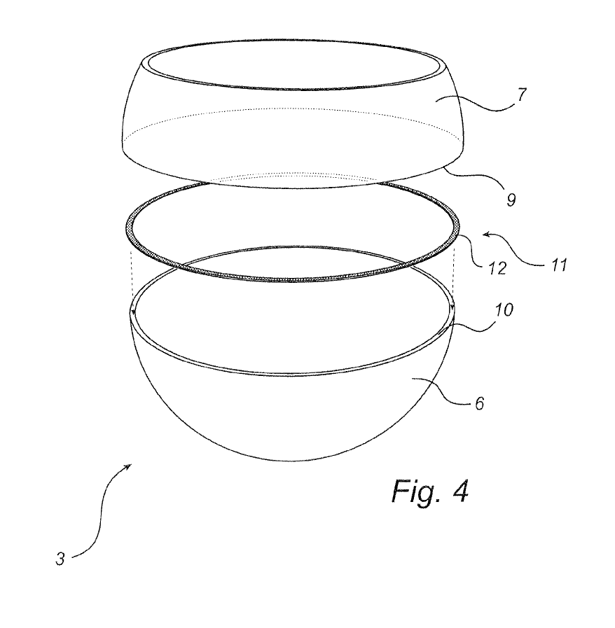

A light absorber 11 is arranged in the joint 8, which is shown in more detail in FIG. 4 to which reference now also is made. The light absorber 11 may alternatively or additionally be arranged on the joint, which will be explained in detail below.

The light absorber 11 comprises a covering 12 with light absorbing properties and which is applied on at least one of the joint ends 9, 10 of the first and second sections 6, 7.

The purpose of the light absorber 11 is to eliminate or at least substantially reduce light reflections in the joint 8.

In the embodiment shown in FIG. 4, the covering 12 is in form of a double sided tape. The tape may be matte black in order to render it light absorbing properties. The double sided tape is also used for the joining of the first and second sections 6, 7.

Alternatively, the covering 12 may be in the form of a pigmented adhesive. A pigment coloring the adhesive matte black may be used in order to render the adhesive light absorbing properties. An example of such a pigment is carbon black. The adhesive may also be used for the joining of the first and second sections.

According to a further alternative, the covering may be in the form of a pigmented coating, ink or paint. A pigment coloring the coating, ink or paint matte black may be used in order to render the coating, ink or paint light absorbing properties. An example of such a pigment is carbon black.

Thus, in accordance with the present invention, a dome window 3 for a surveillance camera device 1 is provided. The dome window 3 comprises a first section 6 and a second section 7, which sections 6,7 are joined along a joint 8, and a light absorber 11 is arranged in or on the joint 8.

The dome window 3 will consequently exhibit a joint 8. When in use, the joint 8 will be positioned in the line of sight of the lens arrangement 4 for certain orientations of the lens arrangement 4. However, the light absorber 11 arranged in or on the joint 8, will have the effect of the joint 8 only appearing as a thin dark line not reflecting any light, and for most zoom settings of the lens arrangement 4, the joint 8 will be more or less invisible in an image acquired by the lens arrangement 4.

The fact that the light absorber 11 eliminates or at least substantially reduces light reflections in the joint 8 will result in significantly enhanced image quality since these reflections otherwise would be clearly visible in the image.

In most zoom settings, such in zoomed-in situations, the joint 8, appearing as a thin dark line, will be practically invisible in the acquired image and will only act as a diaphragm slightly but negligible reducing the amount of incoming light to the lens arrangement 4. In fully zoomed-out situations, the joint 8 might be slightly visible in the image as a line shaped shadow.

In order to minimize the influence of the joint 8 on the image quality, the distance D between the front lens surface 5 of the lens arrangement 4 and the joint 8, i.e. the inside surface of the dome window 3, should be kept as small as possible. Practically, the distance D may be in the range of 1-20 mm and more preferable 4-10 mm. The distance D may, as mentioned above, be kept constant or nearly constant to the spherically shaped parts of the dome window 3 during tilting and/or rotation of the lens arrangement 4.

It is understood that the present invention is not limited to the above described embodiments.

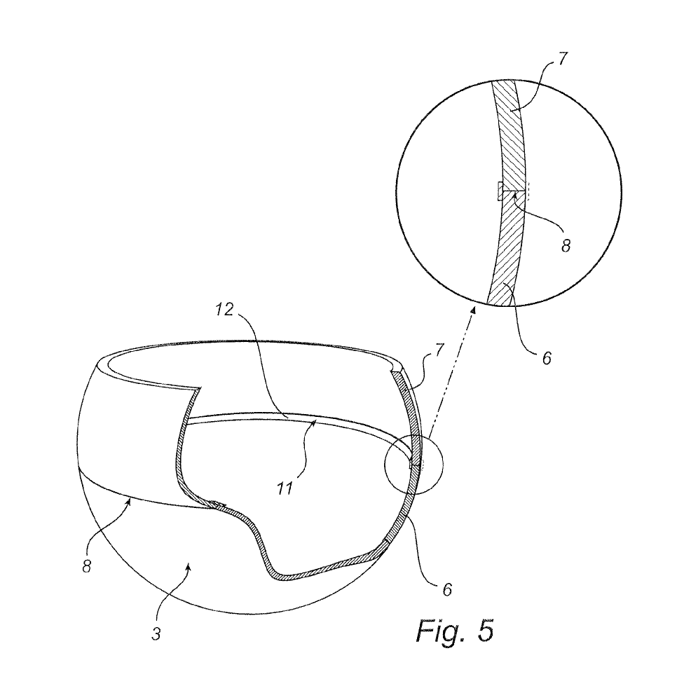

As mentioned above, the light absorber might alternatively or additionally be applied on the joint. Thus, in accordance with a third embodiment of the inventive dome window 3, a covering 12 in the form of a matte black tape may be applied on the inside of the dome window 3 with an extension over the joint 8, as shown in FIG. 5. It is understood that the covering alternatively or additionally may be applied over the joint on the outside of the dome window (shown in dotted lines).

Further, the second section 7 of the dome window 3 may be given another shape than that of a spherical segment. In FIG. 3, to which reference now is made, a second embodiment of the inventive dome window 3 is shown. In this embodiment, the second section 7 has been given a cylindrical shape. The image quality will be affected when a lens arrangement 4 is viewing outward through both the hemispherical first section 6 and the cylindrical section 7 of the dome window 3 due to optical effects, but negative influences due to light reflections in the joint have been eliminated or at least significantly reduced by means of the light absorber 11 arranged in the joint 8.

Additional shapes of the second section are also conceivable. For instance, the second section may be given the form of a truncated cone.

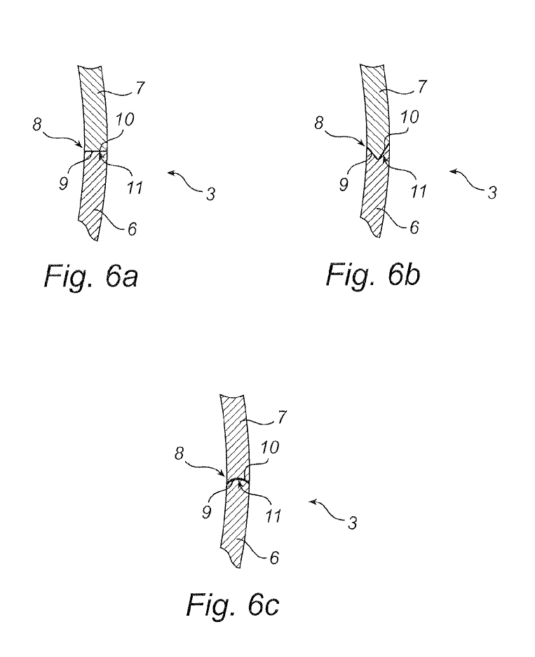

In the embodiments of the dome window shown in FIGS. 2 and 3, the joint ends of the first and second sections have corresponding cross-section profiles extending straight in radial direction, which is shown in FIG. 6a depicting a cross sectional view of a part of the dome window 3 comprising the joint 8. It is understood that the cross-section profiles may be given other shapes. The corresponding cross-section profiles of the joint ends of the first and second sections may for instance extend obliquely or have a V- or U-shape, as shown in FIGS. 6b and 6c, respectively. By forming the joint ends with corresponding cross-section profiles, it will be possible to minimize the joint size and also to provide a guide mutually aligning the first and second sections during joining of the same.

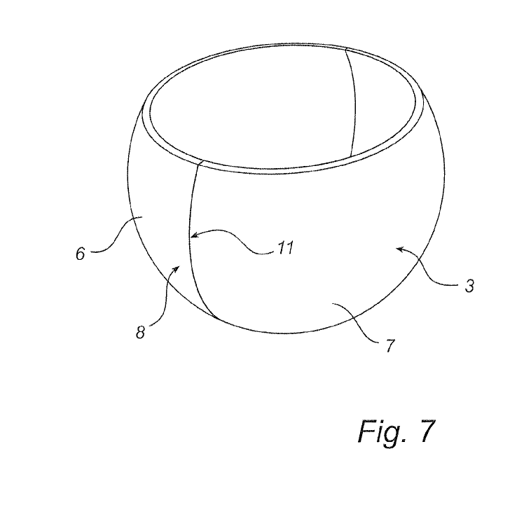

In the embodiments shown above, the joint has a horizontal or latitudinal orientation. It is understood that the joint and the light absorber arranged in or on the joint might have other orientations. In accordance with a fourth embodiment of the inventive dome window 3, such another orientation may be a vertical or longitudinal orientation, which is shown in FIG. 7. For a dome window with a shape corresponding to the ones shown in FIGS. 2 and 3, this would result in the first and second sections being mirror images of each other.

Consequently several modifications and variations are conceivable, which means that the present invention is exclusively defined by the appended claims.

What is claimed is:

1. A dome window for a surveillance camera device, comprising a first section and a second section, wherein the first section is joined to the second section along a joint in which a joint end of the first section is attached to a joint end of the second section, wherein a light absorber is arranged in or on the joint.

2. The dome window according to claim 1, in which the light absorber comprises a covering with light absorbing properties applied on at least one of the joint ends of the first and second sections.

3. The dome window according to claim 1, in which the light absorber comprises a covering with light absorbing properties applied on the inside or the outside of the dome window and extending over the joint.

4. The dome window according to claim 3, in which the covering with light absorbing properties is selected from the group consisting of a tape, a double sided tape, a pigmented adhesive and a pigmented coating, ink or paint.

5. The dome window according to claim 1, in which the joint ends have corresponding cross section profiles.

6. The dome window according to claim 1, in which the first section has a hemispheric shape.

7. The dome window according to claim 1, in which the second section has a shape of a spherical segment.

8. The dome window according to claim 6, in which the first and second sections form parts of a common sphere shape.

9. The dome window according to claim 1, in which the joint is annular.

10. The dome window according to claim 1, in which the first section is a mirror image of the second section.

11. The dome window according to claim 1, in which the wall thickness of the first and second sections is in the range of 1 to 2 mm.

12. The dome window according to claim 1, in which the first and second sections are made of a plastic material such as PMMA or PC.

13. A surveillance camera device comprising the dome window according to claim 1.

14. The surveillance camera device according to claim 13, comprising a tilt-able or rotatable lens arrangement with a front lens surface arranged at a constant distance to a hemispherical part of the dome window.

15. The surveillance camera device according to claim 14, in which the distance is in the range of 1-20 mm and more preferably 4-10 mm.
